(19) United States
(12) Patent Application Publication
(10) Pub. No.: US 2008/0162282 A1
(43) Pub. Date: Jul. 3, 2008

(54) Methods, systems, and products to distributing reward points

(76) Inventor: William Gaylord, Stone Mountain, GA (US)

Correspondence Address: SCOTT P. ZIMMERMAN, PLLC, PO BOX 3822, CARY, NC, 27519, US

(21) Appl. No.: 11/649,187

(22) Filed: Jan. 3, 2007

(51) Int. Cl. G06Q 30/00

(52) U.S. Cl. 705/14

(57) ABSTRACT

Methods, systems, and products are disclosed for distributing reward points. Blocks of point are assigned to at least one advertiser for distribution in advertising. An account is established for a user. A credit request is received from the user for processing an advertiser's content. A predetermined number of points associated with the content is debited from the advertiser's block of points and credited to the user's account.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The exemplary embodiments generally relate to computers and to data processing and, more particularly, to distribution of incentives for receiving, viewing, or otherwise processing advertisements.

Users may need motivation to respond to advertising. As more and more users gain access to on-demand programming and to the Internet, their time and attention become more fragmented. If advertising does not immediately appeal to an individual user, that user is likely to “surf” for alternate programming or content. Even the advent of “pop-up” ads or web pages is considered more of a nuisance than effective advertising. What is needed, then, are methods, systems, and products that entice users to accept advertising content and even motivate users to interact with that advertising content.

### SUMMARY

The exemplary embodiments provide methods, systems, and products for rewarding users to accept advertising content. When a user accepts, stores, displays, or otherwise processes an advertiser's content, the advertiser rewards the user with points. Each user has an individual account that is credited with points for processing advertising content. These reward points thus motivate or entice the user to accept advertising content, and the user may redeem these points for cash or merchandise. Exemplary embodiments, however, also debit points from the advertiser. The advertiser has a block of points that may be distributed to users. When the user processes the advertiser's content, its corresponding points are debited from the advertiser's block of points and credited to the user's account. Exemplary embodiments also manage the distribution of the points for the advertiser. Once the advertiser assigns the reward points to advertising content, exemplary embodiments divorce the advertiser from accounting for those points and for redeeming those points. Exemplary embodiments, instead, permit a third party to manage and tally the accounts, thus freeing the advertiser of those administrative burdens. The advertiser thus purchases only those blocks of points that the advertiser needs, and the third party manages other aspects of the reward campaign.

Exemplary embodiments include a method to distribute reward points. Blocks of points are assigned to at least one advertiser for distribution in advertising. An account is established for a user. A credit request is received from the user for processing an advertiser's content. A predetermined number of points associated with the content is debited from the advertiser's block of points and credited to the user's account.

More exemplary embodiments include a server to distribute reward points at least one advertiser advertisers for distribution in advertising. An account is established for a user. A credit request is received from the user for processing an advertiser's content. A predetermined number of points associated with the content is debited from the advertiser's block of points and credited to the user's account.

Other exemplary embodiments describe a computer program product for distributing reward points. The computer program product comprises computer-readable instructions for assigning blocks of points to at least one advertiser for distribution in advertising. An account is established for a user. A credit request is received from the user for processing an advertiser's content. A predetermined number of points associated with the content is debited from the advertiser's block of points and credited to the user's account.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a schematic illustrating a network environment in which exemplary embodiments may be implemented;

FIG. 2 is a schematic illustrating a process for distributing reward points, according to more exemplary embodiments;

FIG. 3 is a schematic illustrating another process for distributing reward points, according to even more exemplary embodiments

FIG. 4 is a schematic illustrating another process for distributing reward points, according to more exemplary embodiments;

FIG. 5 is a schematic illustrating a process for redeeming reward points, according to still more exemplary embodiments;

FIG. 6 is a schematic illustrating an alternative environment in which more exemplary embodiments may be implemented;

FIG. 7 is a flowchart illustrating a method to distribute reward points, according to still more exemplary embodiments;

FIG. 8 is a flowchart illustrating another method to distribute reward points, according to even more exemplary embodiments; and

FIG. 9 depicts other possible operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

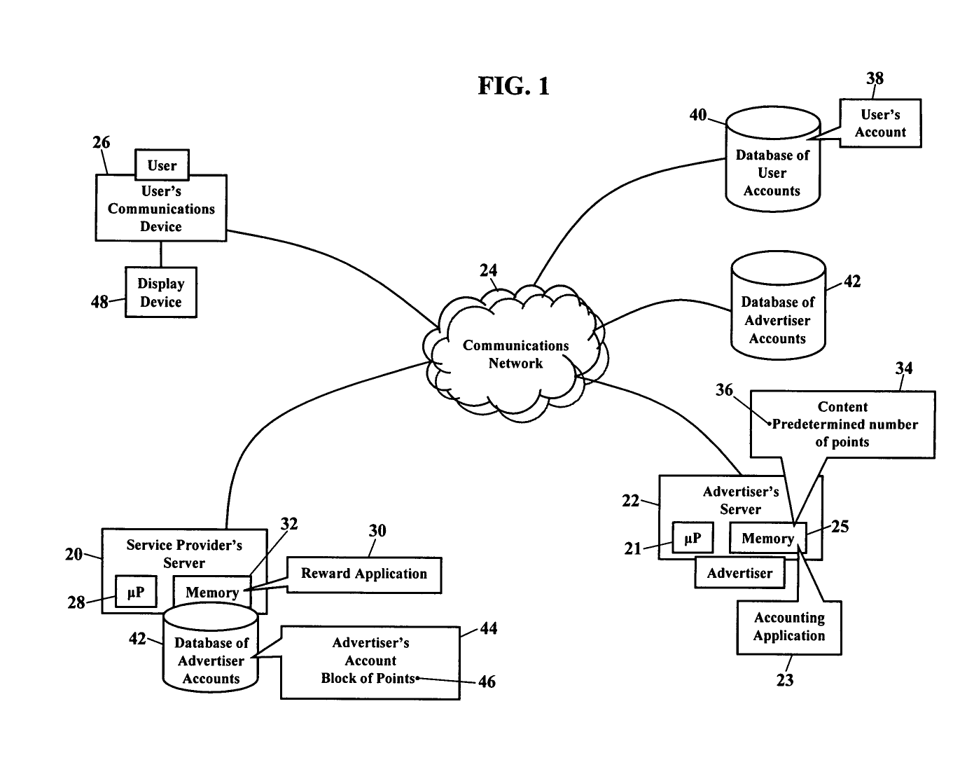

FIG. 1 is a schematic illustrating a network environment in which exemplary embodiments may be implemented. A service provider's server 20 communicates with an advertiser's server 22 via a communications network 24. The service provider's server 20 also communicates with a user's communications device 26 via the communications network 24. The service provider's server 20 has a processor 28 (e.g., “μP”), application specific integrated circuit (ASIC), or other similar device that executes a reward application 30 stored in memory 32. The reward application 30 is a software engine or computer program that rewards the user for processing advertisements, websites, or other content. That is, when the user's communications device 26 receives, stores, displays, or otherwise processes electronic advertising content 34, for example, the advertiser rewards the user with a predetermined number 36 of points. According to exemplary embodiments, the user has an individual account 38 that is maintained in a database 40 of user accounts. The database 38 of user accounts is illustrated as being remotely accessed via the communications network 24, but the database 38 may be locally stored in the memory 32 of the service provider's server 20. When the user's communications device 26 processes the content 34, the reward application 30 may credit the user's account 38 with the predetermined number 36 of points associated with the content 34.

The reward motivates or entices the user. The user, for example, may be rewarded with “Frequent Surfer Points” for simply viewing an advertisement or browsing/surfing website. As FIG. 1 illustrates, the advertiser's server 22 has a processor 21 (e.g., “μP”), application specific integrated circuit (ASIC), or other similar device that executes an accounting application 23 stored in memory 25. The advertiser's server 22 may also store the electronic advertising content 34 in the memory 25. When the user's communications device 26 requests the electronic advertising content 34, the advertiser's server 22 may communicate the electronic advertising content 34 to the user's communications device 26 via the communications network 24. When the user's communications device 26 processes electronic advertising content 34, the accounting application 23 cooperates with the reward application 30 to reward the user with the predetermined number 36 of points associated with the content 34. The user's account 38 is credited with the predetermined number 36 of points associated with the content 34.

Any reward scheme may be used. The user's account 38 may be rewarded for any interaction with the content 34. A small amount or a portion of the predetermined number 36 of points may be awarded for viewing, listening to, or otherwise processing a portion of the content 34. All of the predetermined number 36 of points may be awarded for viewing, listening to, or otherwise processing all of the content 34. The portion of the predetermined number 36 of points awarded may depend on the portion of the content 34 processed. In further embodiments, points may only be awarded if all of the content is viewed, listened to, or otherwise processed. The content 34 may be interactive, in which the user is progressively rewarded with more points by providing feedback and/or “drilling down” into various layers or pages. If the user merely views the content 34, the user may receive a small amount of points. If the content 34 contains links to additional content, the user may receive points for requesting/downloading that additional content. Points may be earned for viewing/consuming media objects/elements, or points may be earned by activity/interactions (accomplishing tasks, like surveys). Purchases may also earn points. Whatever reward scheme is used, the reward application 30 credits the user's account 38 with the predetermined number 36 of points associated with the content 34.

According to exemplary embodiments, the reward application 30 also debits points from the advertiser. As FIG. 1 illustrates, the service provider's server 20 also accesses a database 42 of advertiser accounts. The database 42 of advertiser accounts may be locally maintained in the memory 32 of the service provider's server 20, or the database 42 of advertiser accounts may be remotely accessed via the communications network 24. However the database 42 of advertiser accounts is accessed, each advertiser may have an individual account 44 in the database 42 that is associated with a block 46 of points. The service provider may sell, rent, or otherwise assign the block 46 of points to the advertiser for use in advertising. When the user's communications device 26 processes the content 34, the reward application 30 debits points from the advertiser's block 46 of points. When the user views the content 34 on a display device 48, for example, the reward application 30 debits the predetermined number 36 of points from the advertiser's block 46 of points. The reward application 30 also credits the user's account 38 with the same predetermined number 36 of points associated with the content 34.

A simple example helps illustrate exemplary embodiments. Suppose BELLSOUTH® is a service provider that offers blocks of points to HOME DEPOT®, GENERAL MOTORS®, TARGET®, and any other advertiser. These advertisers develop advertisements for their respective products and services, and the advertisers make those advertisements available to users. Each advertiser, however, also assigns points to each advertisement. Suppose also that GM® awards 100 points to any user that watches a GM® advertisement. When the user's communications device 26 (such as a computer, a set-top box, or any other communications device) visually and/or audibly processes one of GM's advertisements, BELLSOUTH® subtracts or debits 100 points from GM's block of points. BellSouth's reward application 30 also credits the user's account 38 with 100 points. BellSouth's reward application 30 thus completely accounts for the advertiser's point usage. As later paragraphs will explain, when the user wishes to redeem points in the user's account 38, BELLSOUTH® may even manage the advertiser's redemption program.

According to exemplary embodiments, the reward application 30 completely manages the distribution of rewards. The advertiser need only determine what number of points is awarded for processing the content 34. The electronic copy of the content 34 may be coded with information that describes the predetermined number 36 of points assigned by the advertiser. Afterwards the advertiser is divorced from accounting for those points and for redeeming those points. The service provider, instead, assumes those tasks on behalf of the advertiser. So, even though the advertiser may determine how many points are rewarded for the content 34, the service provider handles all the accounting. That is, the service provider's reward application 30 establishes, manages, and tallies the accounts, thus freeing the advertiser of those administrative burdens. As later paragraphs will explain, whenever the advertiser's block 46 of points is nearly consumed, the reward application 30 may even alert the advertiser and permit the advertiser to purchase more blocks of points. The advertiser may thus purchases only those blocks of points that the advertiser needs. Moreover, because the reward application 30 completely manages the points program, the advertiser may confidently stay within their advertising campaign budget.

The block 46 of points may have any value. The service provider, for example, may offer a block of 100 points, a block of 1,000 points, and/or a block of 10,000 points. The service provider, in fact, may offer any number of points per block. The service provider may even offer a graduated scheme, in which the service provider sells larger blocks of points for a discounted price. Advertisers may thus purchase whatever size of blocks that best suits their advertising campaign and budget.

The user may be authenticated. When the user registers with the reward application 30, the user's communications device 26 may receive an electronic certificate. This electronic certificate identifies user and/or the user's account 38. When the user's communications device 26 then requests the content 34, the user's communications device 26 may send the electronic certificate to the advertiser's server 22. When the user's communications device 26 processes the electronic advertising content 34, the accounting application 23 may send an account transaction to the reward application 30 operating in the service provider's server 20. The account transaction identifies the user's account and the predetermined number 36 of points associated with the content 34. The user's account 38 is thus credited with the predetermined number 36 of points associated with the content 34. Electronic certificates are known to those of ordinary skill in the art and will not be further explained.

Exemplary embodiments may be applied to any service provider and/or advertiser. The term “service provider” includes any person, business, merchant, or other entity that offers a product or service. The service provider may be any entity that only offers goods and/or services via an online presence, such as an e-commerce website. The service provider, however, may also have a physical presence, such as a warehouse, retail storefront, or catalog mailing. The term “advertiser” includes any person, business, or other entity that advertises a product or service.

Exemplary embodiments may be applied to any server and to any reward application. The service provider's server 20, for example, may be configured as a conventional web server or as a specially-configured streaming server. The reward application 30 may be any software application, plug-in, and/or hardware component that manages rewards or incentives. The reward application 30 may even be incorporated into, or cooperate with, a search engine for finding and/or retrieving advertising content. Exemplary embodiments may even be incorporated into media players that process advertisements, such as Microsoft's Media Player and RealNetwork's REALPLAYER™.

Exemplary embodiments may also be applied regardless of networking environment. The communications network 24 may be a cable network operating in the radio-frequency domain and/or the Internet Protocol (IP) domain. The communications network 24, however, may also include a distributed computing network, such as the Internet (sometimes alternatively known as the “World Wide Web”), an intranet, a local-area network (LAN), and/or a wide-area network (WAN). The communications network 24 may include coaxial cables, copper wires, fiber optic lines, and/or hybrid-coaxial lines. The communications network 24 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

The service provider's server 20, the advertiser's server 22, and the user's communications device 26 are only simply illustrated. Because the architecture and operating principles of these devices are well known, their hardware and software components are not further shown and described. If the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Some aspects of incentive advertising are known, so this disclosure will not greatly explain the known details. If the reader desires more details, the reader is invited to consult the following sources, all incorporated herein by reference in their entirety: U.S. Pat. No. 5,794,210 to Goldhaber et al. (Aug. 11, 1998); U.S. Pat. No. 6,061,660 to Eggleston et al. (May 9, 2000); U.S. Pat. No. 6,381,632 to Lowell (Apr. 30, 2002); U.S. Pat. No. 7,054,830 to Eggleston et al. (May 30, 2006); U.S. patent application Publication 2001/0056374 to Joao (Dec. 27, 2001); U.S. patent application Publication 2002/0116266 to Marshall (Aug. 22, 2002); U.S. patent application Publication 2002/0133402 to Faber et al. (Sep. 19, 2002); U.S. patent application Publication 2003/0208754 to Sridhar et al. Nov. 6, 2003); U.S. patent application Publication 2004/0025174 to Cerrato (Feb. 5, 2004); U.S. patent application Publication 2005/0096975 to Moshe (May 5, 2005); U.S. patent application Publication 2005/0114210 to Faber et al. (May 26, 2005); and U.S. patent application Publication 2006/0053049 to Nolan (Mar. 9, 2006).

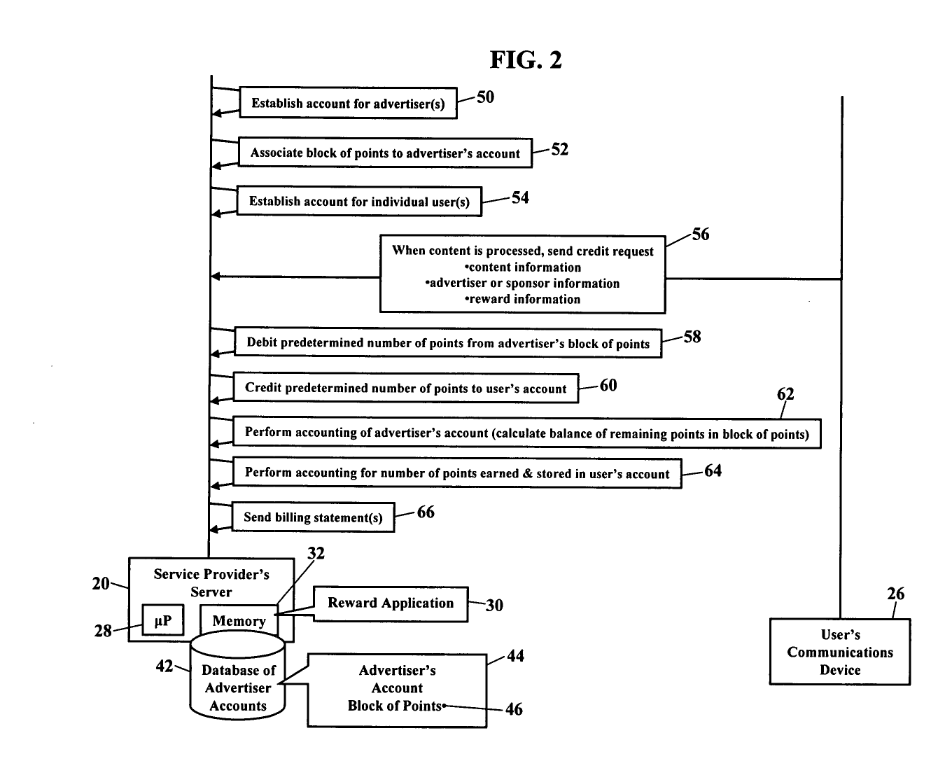

FIG. 2 is a schematic illustrating a process for distributing reward points, according to more exemplary embodiments. The reward application 30, operating in the service provider's server 20, establishes an account for an advertiser (Step 50) and associates a block of points to the advertiser's account (illustrated, respectively, as reference numerals 46 and 44 in FIG. 1) (Step 52). The reward application 30 also establishes an account for an individual user (Step 54). When the user's communications device 26 processes the content 34 associated with the advertiser, the user's communications device 26 sends a credit request to the service provider's server 20 (Step 56). The credit request may comprise content information that uniquely identifies the content 34, such as a unique number associated with the content 34. The credit request may comprise user information that uniquely identifies the user and/or the user's communications device, such as a unique number associated with the user. The credit request may also comprise advertiser or sponsor information that uniquely identifies the advertiser, such as a unique number associated with the advertiser. The credit request may also comprise reward information that identifies an incentive the user receives for processing the content. The reward information, for example, may comprise information that describes the predetermined number 36 of points that are awarded for processing the associated content 34.

The reward application 30 accounts for the rewards. When the service provider's server 20 receives the credit request, the reward application 30 debits the predetermined number 36 of points from the advertiser's block 46 of points (Step 58). The reward application 30 then credits the same predetermined number 36 of points to the user's account 38 (Step 60). The reward application 30 may perform an accounting of the advertiser's account 44 (Step 62), such as calculating and maintaining a tally or balance of the remaining points in the block 46 of points. The reward application 30 may also account for the number of points earned and stored in the user's account 38 (Step 64). The reward application 30 may even send billing statements to the advertiser's server or to the user's communications device 26 for managing the advertiser's account 44 and/or for managing the user's account 38 (Step 66).

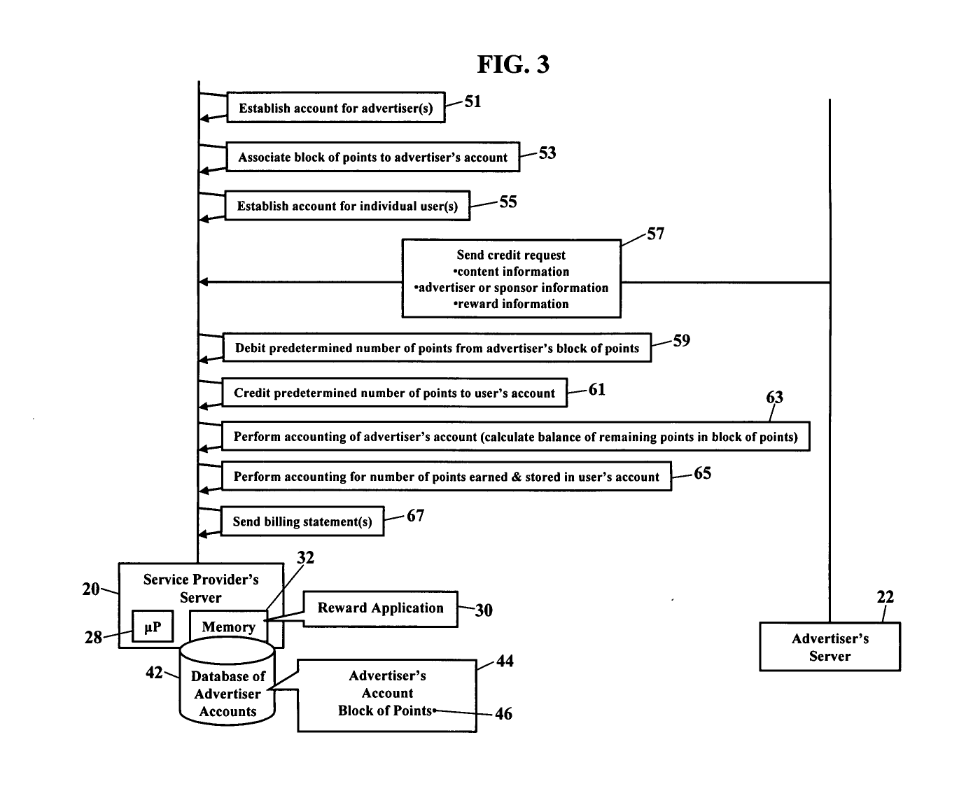

FIG. 3 is a schematic illustrating another process for distributing reward points, according to even more exemplary embodiments. Here the advertiser's server 22 sends a credit request to the service provider's server 20. As FIG. 3 illustrates, the reward application 30, operating in the service provider's server 20, establishes an account for an advertiser (Step 51) and associates a block of points to the advertiser's account (Step 53). The reward application 30 also establishes an account for an individual user (Step 55). When the user's communications device 26 processes the content 34 associated with the advertiser, the advertiser's server 22 sends a credit request to the service provider's server 20 (Step 57). The credit request may again comprise the content information, the advertiser or sponsor information, and/or the reward information (such as the predetermined number 36 of points for processing the associated content 34).

The reward application 30 accounts for the rewards. The reward application 30 debits the predetermined number 36 of points from the advertiser's block of points (Step 59). The reward application 30 credits the same predetermined number 36 of points to the user's account (Step 61). The reward application 30 performs an accounting of the advertiser's account (Step 63), such as calculating and maintaining a tally or balance of the remaining points in the block of points. The reward application 30 also accounts for the number of points earned and stored in the user's account (Step 65). The reward application 30 may send billing statements to the advertiser's server or to the user's communications device 26 for managing the advertiser's account and/or for managing the user's account (Step 67).

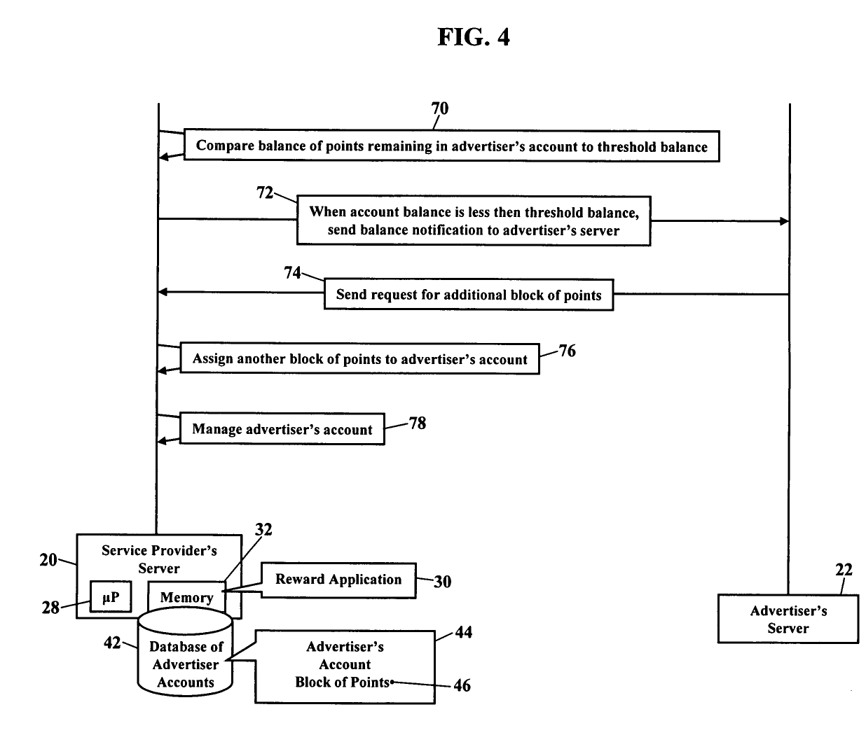

FIG. 4 is a schematic illustrating another process for distributing reward points, according to more exemplary embodiments. Here the reward application 30 replenishes the advertiser's account 44 with additional points. The advertiser may compensate or reward many users for processing advertisements, websites, and other content. As those users' accounts are credited with reward points, the advertiser's block 46 of points may be quickly consumed. Because, however, the reward application 30 may manage the advertiser's account 44, the reward application 30 may alert the advertiser when the block 46 of points is nearly exhausted. As FIG. 4 illustrates, the reward application 30 compares the balance of points remaining in the advertiser's account 44 to a threshold balance (Step 70). When the advertiser's account balance is less than the threshold balance, the reward application 30 may send a balance notification to the advertiser's server 22 (Step 72). The balance notification alerts the advertiser that their block 46 of points is nearly exhausted. The advertiser's server 22 may then send a request for an additional block of points (Step 74), thus allowing the advertiser to determine or control whether more points are desired. When the reward application 30 receives the request, the reward application 30 assigns another block of points to the advertiser's account (Step 76) and continues managing the advertiser's account (Step 78).

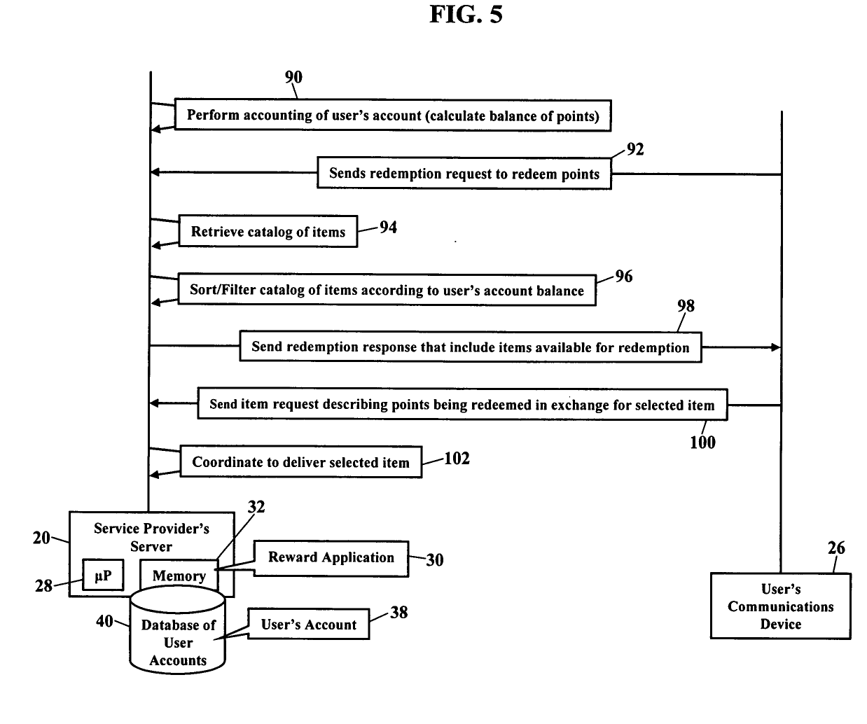

FIG. 5 is a schematic illustrating a process for redeeming reward points, according to still more exemplary embodiments. Here the reward application 30 manages, on behalf of the advertiser, the redemption of points in the user's account 38. The reward application 30 performs an accounting of the user's account 38 (Step 90) by calculating and maintaining a tally or balance of the number of points earned and stored in the user's account 38. When the user wishes to redeem some or all of those points, the user's communications device 26 sends a redemption request to the service provider's server 20 (Step 92). The redemption request seeks to redeem points from the user's account 38 in exchange for cash or a prize. When the service provider's server 20 receives the redemption request, the reward application 30 may retrieve a catalog of items from the memory 32 (Step 94). The reward application 30 may even sort or filter the catalog of items according to the user's account balance (Step 96). The reward application 30 may then send a redemption response to the user's communications device 26 (Step 98), and the redemption response includes the catalog of items that are available for redemption. When the user selects an item from the catalog for redemption, the user's communications device 26 sends an item request to the service provider's server 20 (Step 100). The item request may describe how many points are being redeemed in exchange for the selected item. When the service provider's server 20 receives the item request, the reward application 30 may coordinate with a supplier or shipper to deliver the selected item (Step 102).

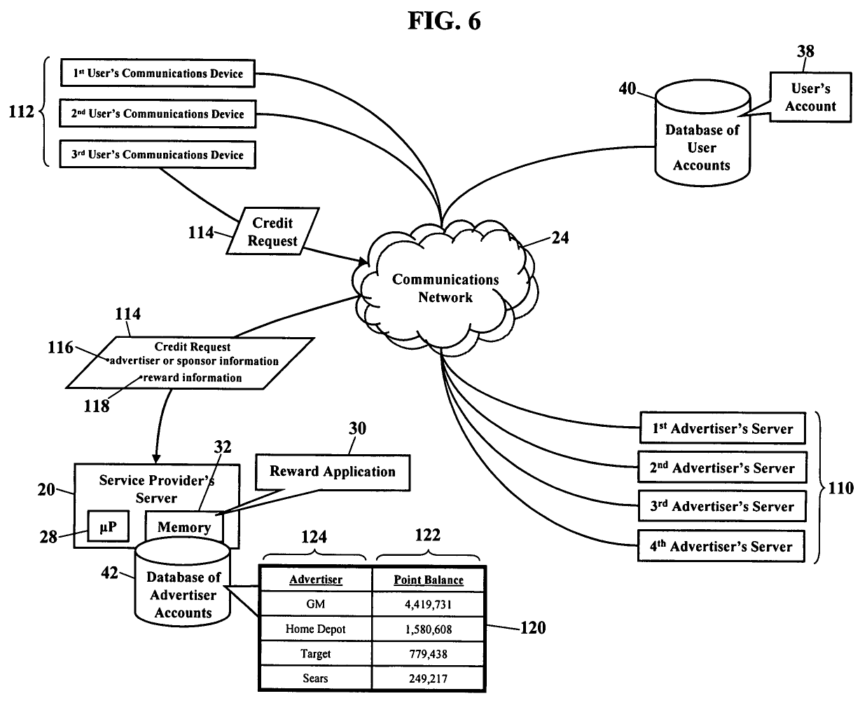

FIG. 6 is a schematic illustrating an alternative environment in which more exemplary embodiments may be implemented. Here the service provider manages blocks of points for multiple advertisers. As FIG. 6 illustrates, the service provider's server 20 communicates with multiple advertisers' servers 110 and with multiple users' communications devices 112. When any of the users' communications devices 112 processes any participating advertiser's electronic content, a credit request 114 is sent to the service provider's server 20. According to exemplary embodiments, the reward application 30 reads or extracts advertiser or sponsor information 116 that uniquely identifies the advertiser. The reward application 30 also reads or extracts reward information 118 that identifies the user and/or the incentive the user receives for processing the content. The reward application 30 then accesses the database 42 of advertiser accounts. The database 42 of advertiser accounts may store a table 120 or matrix that maps, relates, or otherwise associates an account balance 122 to each advertiser 124. The reward application 30 queries the database 42 of advertiser accounts for the account balance 122 associated with the advertiser 124 identified in the credit request 114. The reward application 30 subtracts or debits the awarded points from the advertiser's account balance and then updates the advertiser's account with the new balance.

The reward application 30 may also access the database 40 of user accounts. According to exemplary embodiments, the database 40 of user accounts stores or maintains a reward account for each individual user. The database 40 of user maps, relates, or otherwise associates an account balance to each user. The reward application 30 queries the database 40 of user accounts for the account balance associated with the user identified in the credit request 114. The reward application 30 adds or credits the awarded points to the user's account balance and then updates the user's account with the new balance. Because the database 40 of user accounts, and each user's account balance, is known to those of ordinary skill in the art, the database 40 of user accounts is only simply shown.

The reward application 30 manages the distribution of rewards on behalf of the multiple advertisers. The individual advertisers only determine what number of points is awarded for processing the content 34. Afterwards the advertisers are divorced from accounting for those points and for redeeming those points. The lone or single service provider, instead, assumes those tasks on behalf of the advertisers. So, as the advertisers' blocks of points are consumed, the advertisers need not be burdened with managing those blocks of points. The service provider's reward application 30 establishes, manages, and tallies the accounts, thus freeing the advertisers to concentrate their efforts on other matters.

The blocks of points may be commonly branded. Because the service provider's reward application 30 manages the distribution and redemption of all the advertisers' points, the service provider may decide to commonly brand the points. That is, regardless of what advertiser awards the points, the points may only be redeemed for a single service provider's goods and services. Suppose again that HOME DEPOT®, GENERAL MOTORS®, MCDONALD'S®, and TARGET® all offer reward points from BELLSOUTH®. These service providers purchase blocks of points from BELLSOUTH® and distribute those points in their advertising. According to exemplary embodiments, if those points are all commonly branded, then those points may only be redeemed from BELLSOUTH®. That is, even if users are rewarded for watching, listening to, or otherwise processing advertisements from HOME DEPOTS, those users may only redeem the points for goods and services offered by, or though, BELLSOUTH®. The points may all be commonly branded for redemption from a single service provider. BELLSOUTH®, however, may choose to partner with other service providers to offer other service providers' products or services for redemption of points. BELLSOUTH®, for example, may partner with SEARS® to redeem reward points for BELLSOUTH® services, for CRAFTSMAN® tools, and for other products from SEARS®. So the blocks of points may be commonly branded with a partnership between two or more service providers.

The points may also be treated as currency. That is, the points may be generically-branded and the points may, or may not, have a monetary value. Each point may have some value that is accepted for goods and services amongst advertisers. Because the points may be accepted as currency, the reward points may be used to redeem any product or service from any advertiser.

Points may also be exchanged. The user may be permitted to exchange one advertiser's points for another advertiser's points. The advertisers may establish amongst themselves a rate of exchange. If the points are generically-branded (discussed above), generically-branded points may be exchanged for an advertiser's uniquely branded points. Users may, if permitted, trade one advertiser's points for another advertiser's points.

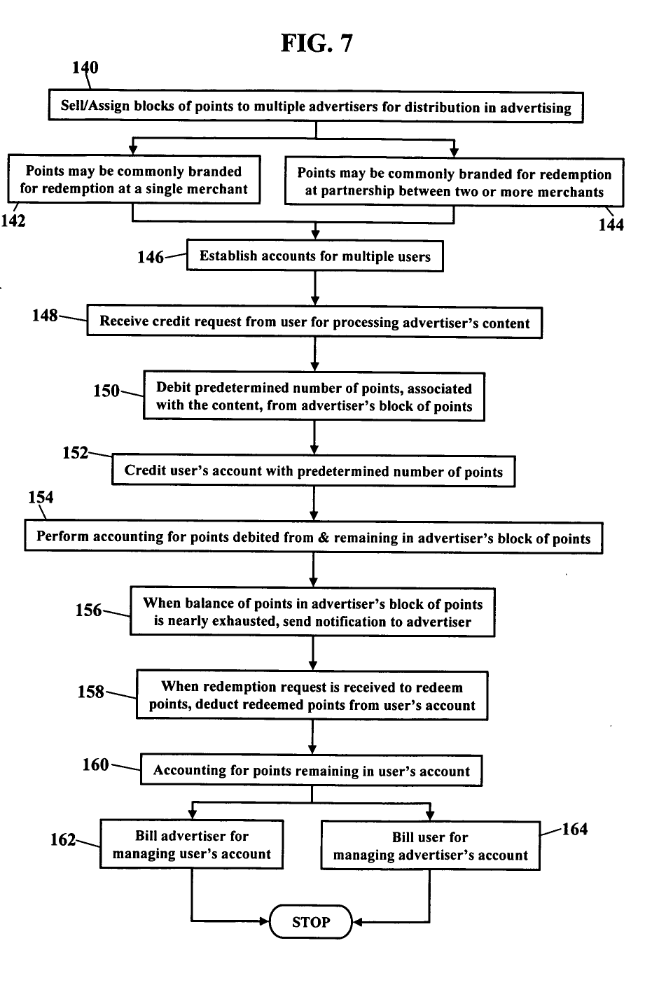

FIG. 7 is a flowchart illustrating a method to distribute reward points, according to still more exemplary embodiments. Blocks of points are sold or assigned to multiple advertisers for distribution in advertising (Block 140). The points may be commonly branded for redemption at a single service provider (Block 142) or at a partnership between two or more service providers (Block 144). Accounts may also be established for multiple users (Block 146). A credit request is received from a user for processing an advertiser's content, such as the content 34 (Block 148). The credit request seeks credit for the predetermined number 36 of points in exchange for processing the content 34. The predetermined number 36 of points, associated with the content 34, is debited from the advertiser's block 46 of points (Block 150). The user's account 38 is credited with the predetermined number 36 of points (Block 152). An accounting is performed for points debited from, and remaining in, the advertiser's block of points (Block 154). When the balance of points in the advertiser's block of points is nearly exhausted, then a notification is sent from the service provider to the advertiser (Block 156). When a redemption request is received from the user to redeem points in the user's account 38, the redeemed points are deducted from the user's account 38 (Block 158) and an accounting is performed for points remaining in the user's account 38 (Block 160). The advertiser may be billed for managing the user's account (Block 162) and/or the advertiser's account (Block 164).

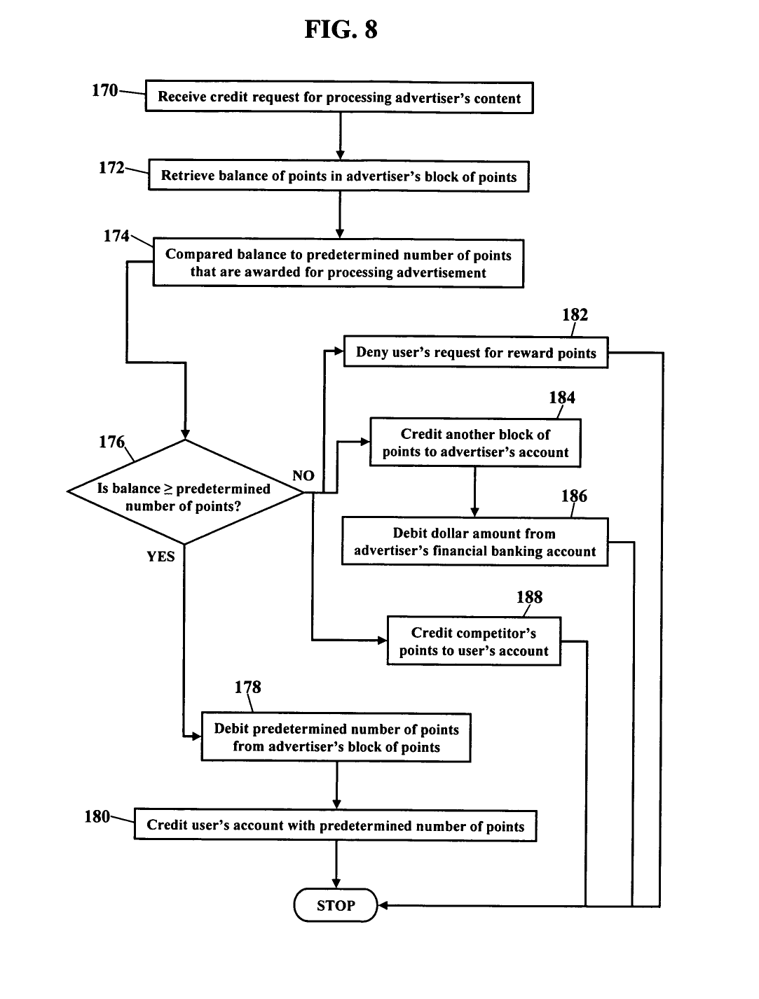

FIG. 8 is a flowchart illustrating another method to distribute reward points, according to even more exemplary embodiments. A credit request is received from a user for processing an advertiser's content 34 (Block 170). The credit request seeks credit for a predetermined number 36 of points in exchange for processing the content 34. A balance of points in the advertiser's block 46 of points is retrieved (Block 172) and compared to a predetermined number of points that are awarded for processing the advertisement (Block 174). If the balance of points in the advertiser's block of points is greater than or equal to the predetermined number of points (Block 176), then the predetermined number of points is debited from the advertiser's block of points (Block 178). The user's account is credited with the predetermined number of points (Block 180).

The service provider may implement options for a negative balance. There may be instances when the advertiser has a negative balance of points. That is, the balance of points in the advertiser's block 46 of points is negative (e.g., less than or equal to zero). This negative balance would usually indicate that the advertiser has misallocated the block of points. Recall that the advertiser determines how many points will be awarded for watching, listening to, or otherwise processing the content 34. If the advertiser misallocates the points, then more points are awarded than are available. When, then, a negative balance is encountered (Block 176), the service provider may implement different options for this negative balance. One option, for example, is to deny the user's request for reward points (Block 182). When the credit request is received (Block 170), and the credit request would result in a negative balance in the advertiser's account (Block 176), then the service provider could deny the user's request (Block 182). That is, the user's communications device 26 has processed the content 34, but the user's reward is denied due to the advertiser's misallocation of points. A message may be sent to the user's communications device 26 indicating that the user's reward is denied due to the advertiser's misallocation of points. This denial, however, penalizes the user for the advertiser's mistake and is likely a less-than-desirable option.

Another option is to credit another block of points to the advertiser's account (Block 184). The service provider, for example, may debit a predetermined dollar amount from the advertiser's financial banking account (Block 186). The service provider may have a contractually-stipulated procedure for automatically replenishing the advertiser's account 44. So, in exchange for crediting the advertiser's account 44 with another block of points, the service provider debits the advertiser's banking account for the purchase price of the block. With this option the service provider simply charges the advertiser for another block of points and credits that additional block to the advertiser's account 44. This option, of course, requires that the service provider have authorization to debit the advertiser's banking account. The service provider, however, may also bill the advertiser, credit the additional block of points, and await payment.

Another option is to discourage misallocation of points. Again recall that the advertiser determines how many points will be awarded for processing the advertiser's content 34. When the advertiser misallocates the points, then the advertiser has awarded more points than are available in the advertiser's account 44. The service provider may discourage a negative balance by crediting a competitor's points to the user's account 38 (Block 188). That is, instead of rewarding the user with the advertiser's points, the user is rewarded with a competitor's points. Here, then, the advertiser is penalized for a negative balance. The threat of this penalty may help ensure that advertisers correctly allocate their reward points in relation to their purchased block(s) of points.

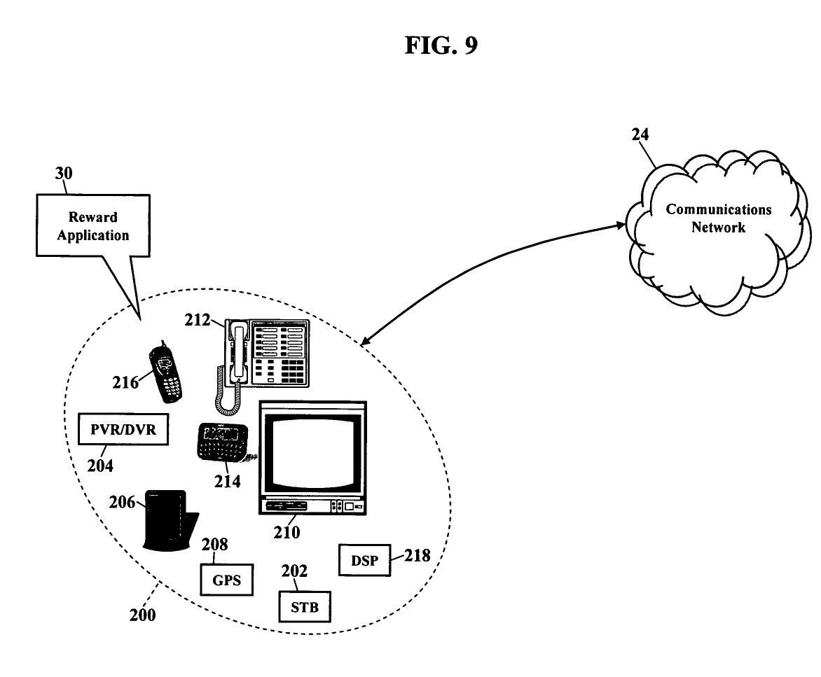

FIG. 9 depicts other possible operating environments for additional aspects of the exemplary embodiments. FIG. 9 illustrates that the reward application 30 may alternatively or additionally operate within various other communications devices 200. FIG. 9, for example, illustrates that the reward application 30 may entirely or partially operate within a set-top box (202), a personal/digital video recorder (PVR/DVR) 204, personal digital assistant (PDA) 206, a Global Positioning System (GPS) device 208, an interactive television 210, an Internet Protocol (IP) phone 212, a pager 214, a cellular/satellite phone 216, or any computer system and/or communications device utilizing a digital signal processor (DSP) 218. The communications device 200 may also include watches, radios, vehicle electronics, clocks, printers, gateways, and other apparatuses and systems. Because the architecture and operating principles of the various communications devices 200 are well known, the hardware and software componentry of the various communications devices 200 are not further shown and described. If, however, the reader desires more details, the reader is invited to consult the following sources, all incorporated herein by reference in their entirety: LAWRENCE HARTE et al., GSM SUPERPHONES (1999); SIEGMUND REDL et al., GSM AND PERSONAL COMMUNICATIONS HANDBOOK (1998); and JOACHIM TISAL, GSM CELLULAR RADIO TELEPHONY (1997); the GSM Standard 2.17, formally known Subscriber Identity Modules, Functional Characteristics (GSM 02.17 V3.2.0 (1995-01))”; the GSM Standard 11.11, formally known as Specification of the Subscriber Identity Module—Mobile Equipment (Subscriber Identity Module—ME) interface (GSM 11.11 V5.3.0 (1996-07))”; MICHEAL ROBIN & MICHEL POULIN, DIGITAL TELEVISION FUNDAMENTALS (2000); JERRY WHITAKER AND BLAIR BENSON, VIDEO AND TELEVISION ENGINEERING (2003); JERRY WHITAKER, DTV HANDBOOK (2001); JERRY WHITAKER, DTV: THE REVOLUTION IN ELECTRONIC IMAGING (1998); and EDWARD M. SCHWALB, ITV HANDBOOK: TECHNOLOGIES AND STANDARDS (2004).

The reward application 30 may be physically embodied on or in a computer-readable media or medium. This computer-readable media/medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the exemplary embodiments, allow the exemplary embodiments to be easily disseminated. A computer program product comprises the reward application 30 stored on the computer-readable media or medium. The reward application 30 comprises computer-readable instructions/code for distributing reward points, as hereinabove explained. The reward application 30 may also be physically embodied on or in any addressable (e.g., HTTP, I.E.E.E. 802.11, Wireless Application Protocol (WAP), or BLUETOOTH®) wireless device capable of presenting an IP address.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method to distribute reward points, comprising:
assigning blocks of points to at least one advertiser for distribution in advertising;
establishing an account for a user;
receiving a credit request from the user for processing an advertiser's content;
debiting a predetermined number of points from the advertiser's block of points; and
crediting the user's account with the predetermined number of points.

2. The method according to claim 1, further comprising receiving a redemption request from the user to redeem points in the user's account.

3. A method according to claim 1, further comprising selling the block of points to the advertiser.

4. A method according to claim 1, further comprising billing the advertiser for managing the user's account.

5. A method according to claim 1, further comprising accounting for points debited from the advertiser's block of points.

6. A method according to claim 1, wherein when the advertiser's block of points is debited to result in a negative balance, then debiting a predetermined dollar amount from the advertiser's account and crediting another block of points to the advertiser.

7. A method according to claim 1, further comprising sending a notification from the service provider to the advertiser when the advertiser's block of points is nearly exhausted.

8. A server that distributes reward points, the server operative to:
assign blocks of points to at least one advertiser for distribution in advertising;
establish an account for a user;
receive a credit request from the user for processing an advertiser's content;
debit a predetermined number of points from the advertiser's block of points; and
credit the user's account with the predetermined number of points.

9. The server according to claim 8, further operative to receive a redemption request from the user to redeem points in the user's account.

10. The server according to claim 8, further operative to sell the block of points to the advertiser.

11. The server according to claim 8, further operative to bill the advertiser for managing the user's account.

12. The server according to claim 8, further operative to account for points debited from the advertiser's block of points.

13. The server according to claim 8, wherein when the advertiser's block of points is debited to result in a negative balance, then the server is further operative to debit a predetermined dollar amount from the advertiser's account and crediting another block of points to the advertiser.

14. The server according to claim 8, further operative to send a notification from the service provider to the advertiser when the advertiser's block of points is nearly exhausted.

15. A computer program product comprising computer-readable instructions for performing the steps:
assigning blocks of points to at least one advertiser for distribution in advertising;
establishing an account for a user;
receiving a credit request from the user for processing an advertiser's content;
debiting a predetermined number of points from the advertiser's block of points; and
crediting the user's account with the predetermined number of points.

16. A computer program product according to claim 15, further comprising instructions for receiving a redemption request from the user to redeem points in the user's account

17. A computer program product according to claim 15, further comprising instructions for selling the block of points to the advertiser.

18. A computer program product according to claim 15, further comprising instructions for billing the advertiser for managing the user's account.

19. A computer program product according to claim 15, further comprising instructions for accounting for points debited from the advertiser's block of points.

20. A computer program product according to claim 15, further comprising instructions for sending a notification from the service provider to the advertiser when the advertiser's block of points is nearly exhausted.
